(19) United States
(12) Patent Application Publication
(10) Pub. No.: US 2007/0083736 A1
(43) Pub. Date: Apr. 12, 2007

(54) Instruction packer for digital signal processor

(76) Inventors: Aravindh Baktha, Portland, OR (US); KS Venkatraman, Hillsboro, OR (US); Darrell D. Boggs, Aloha, OR (US)

Correspondence Address: Richard Calderwood;Stexar Corp., 20400 NW Amberwood Dr. #100, Beaverton, OR, 97006-7099, US

(21) Appl. No.: 11/244,564

(22) Filed: Oct. 6, 2005

(51) Int. Cl. G06F 9/40

(52) U.S. Cl. 712/215; 712/212

(57) ABSTRACT

A digital signal processor which uses a RISC/CISC style front end and a VLIW style back end. Sequential ISA instructions are decoded into μops having a programmatic ordering. The μops are packed into a VLIW-like instruction packet according to a set of rules enforcing machine policy on e.g. data dependency, VLIW slot availability, maximum VLIW width, and so forth. Within the instruction packet, original program order is identified in case it is necessary to perform precise exception handling. The ISA code is executed as though it were on a RISC/CISC machine, but with VLIW style ILP efficiencies.

### BACKGROUND OF THE INVENTION

1. Technical Field of the Invention

This invention relates generally to programmable processing apparatus, and more specifically to microarchitectural details of instruction handling between decoding and execution.

2. Background Art

For convenience, the various machines are illustrated herein in a generally top-to-bottom data flow orientation, such that instructions flow more or less from the top of the drawing to the bottom. The reader should note that this means that instructions appear in bottom-to-top order when shown within an executable code block, with the earliest (oldest) instructions shown at the bottom, closest to the machine, and the latest (newest) instructions shown at the top, generally closer to the compiler.

The term “ISA instruction” will be used when referring to an instruction which is in the native terms of an Instruction Set Architecture (ISA). The terms “micro-instruction” or “μop” will be used when referring to an instruction which results from decoding an ISA instruction into one or more instructions which are in the native terms of a microarchitecture or other characterization of a low-level implementation of a processor. The term “instruction” will be used when referring generically to an ISA instruction and/or a μop. The term “sequential instructions” will be used to refer to instructions which are not organized as VLIW instruction words, such as RISC/CISC code in ISA or μop form.

FIG. 1 illustrates a Very Long Instruction Word (VLIW) processor such as is known in the art. The VLIW processor executes VLIW executable code which is generated from source code by a VLIW compiler. Each horizontal row of instructions in the VLIW executable code is a VLIW instruction word.

The VLIW processor includes an instruction word fetcher which fetches a VLIW instruction word from the executable code, and a dispatcher which issues the fetched instruction word to a plurality of execution units. The execution units may include, for example, two Add/Sub units for performing addition and subtraction operations, a Mul/Div unit for performing multiplication and division operations, a Shifter unit for performing shift and rotate operations, a Logical unit for performing bitwise operations such as AND, OR, and XOR, and a Branch unit for performing control flow branching operations such as jumps and conditional branches.

The VLIW compiler must know certain architectural details of the VLIW processor, such as how many execution units it has, what types of instructions each is capable of executing, which “slots” each instruction occupies across the machine, whether certain instructions can or cannot coexist within the same VLIW instruction word, and so forth. It must also be capable of determining certain things about the source code it is compiling, such as identifying data dependencies, to ensure that it generates valid code that will correctly execute to produce the intended result.

In the interest of clarity of illustration, many well-known features of the VLIW processor have been omitted, such as the register file, as showing them would not add to the skilled reader's understanding of the present invention.

The six instructions of each VLIW instruction word are issued in lock-step to their respective slots' execution units. Virtually all of the scheduling intelligence is in the VLIW compiler; the VLIW processor itself makes no decisions about data dependencies (other than waiting to issue a decoded VLIW instruction word until all of its input data operands are ready), code reordering, and the like. As soon as the longest-latency instruction in the prior VLIW instruction word has completed execution and the next VLIW instruction word's operand data are available, the scheduler ships the next VLIW instruction word to the execution units.

The hardware of the VLIW processor can be significantly simplified, because the instruction scheduling intelligence has been incorporated into the compiler. A significant and unfortunate side-effect of this is that VLIW code suffers greatly from “NOP code bloat”, with typically 25% to 50% of the instruction slots being occupied with “NOP” (no-operation or null operation) instructions that were not present in the source code but were, for any of a variety of scheduling reasons, injected by the compiler.

FIG. 2 illustrates a method of operation of the VLIW processor of FIG. 1. Operation begins (100) with the instruction word fetcher fetching (102) the next VLIW instruction word. The instructions of the fetched VLIW instruction word are then decoded (104). When (106) the operand data are all available and when (108) the execution units are all available, the scheduler issues (110) the decoded instruction word to the execution units, and each execution unit executes (112) the instruction in its slot. If (114) the execution has reached the end of the executable code, execution ends (116), otherwise the processor fetches (102) the next VLIW instruction word.

FIG. 3 illustrates the applicant's understanding of the implementation of the Texas Instruments TMS32064x VLIW Fixed-Point Digital Signal Processor.

The processor operates upon executable code which has been generated from source code by a compiler. The executable code differs from conventional VLIW code in two respects. First, the compiler does not pad the executable code with “NOP” instructions. And second, the instruction slots are not strictly aligned with the execution unit slots.

The compiler constructs “fetch packets” which are 256 bits and 8 instructions wide (although, for ease of illustration, they are shown as only 6 wide). Similarly, the processor is 8 execution units wide (although it is shown as only 6 wide). In FIG. 3, each row of the executable code represents one fetch packet. Within each fetch packet are N “execution packets”, where N is any number from 1 to 8. The least-significant bit (“LSB”) of each 32-bit instruction slot indicates whether that instruction slot is the last in its “execution packet”. The LSBs of the six illustrated instruction slots are respectively shown as “b0” through “b5”. If the execution packet includes M instructions, there are 8-M “implicit NOPs” in the effective VLIW instruction word.

The processor includes a packet fetcher and dispatcher which retrieves a next fetch packet of the executable code, and 8 instruction decoders. The packet fetcher and dispatcher uses the LSB markers to dispatch exactly one execution packet's instructions simultaneously to the decoders.

The output of the decoders is presumably fed to some sort of steering logic, which routes the decoded instructions of the current execution packet to their appropriate execution units. This is necessary because the execution packet is not a full-width, slot-aligned VLIW instruction word. For ease of illustration, FIG. 3 shows only 2 .M execution units, 2 .S execution units, and 2 .L execution units; there are two other execution units which are not shown.

If the current fetch packet includes a second (or subsequent) execution packet, that execution packet's instructions are dispatched together at the following clock cycle, after the previously-dispatched instructions have been executed.

For example, the current fetch packet may include: (1) a first execution packet comprising the instructions in slot0, slot1, and slot2; (2) a second execution packet comprising the instructions in slot3 and slot4; and (3) a third execution packet comprising the instruction in slot5. The LSBs b2, b4, and b5 will be “1” and the others will be “0”. The dispatcher will send the instructions in slot0, slot1, and slot2 to the decoders. The decoders will determine what kinds of instructions those are, and the steering logic will route them to their appropriate execution units. After that first execution packet completes execution, the dispatcher will send the instructions in slot3 and slot4 to the decoders, which will determine what those instructions are, then the steering logic will route them to the appropriate execution units. After that second execution packet completes execution, the dispatcher will send the instruction in slot5 to the decoders, which will determine what kind of instruction it is, and the steering logic will route it to the appropriate execution unit.

At each cycle, the steering logic will presumably indicate to the unused execution units that they are unused, enabling them to remain idle and reduce power consumption.

Thus, this processor enables the use of what is essentially VLIW executable code and a VLIW processor, without “NOP” padding. Execution packets are executed in program order, just as they would have been in a conventional, NOP-padded VLIW processor.

FIG. 4 illustrates a method of operation of the VLIW processor of FIG. 3. Operation begins (120) when the instruction fetcher fetches (122) a next fetch packet of the code. Then, the first execution packet's instructions, as indicated by the LSB markers, are dispatched (124) to the decoders. The dispatched instructions are decoded (126). The decoded instructions are then steered (128) to their appropriate execution units, based on instruction type rather than slot, because they are not slot-aligned. The execution units execute (130) these instructions. Some execution units will typically not have received any decoded instructions; these represent the implicit NOPs. If (132) the instruction chain was broken somewhere other than the final slot (meaning that b5 was not the only “1” among the LSBs), there are more execution packets in the fetch packet, and operation returns to dispatching (124) the next execution packet. Otherwise, if (134) operation has not yet reached the end of the executable code, there are more fetch packets yet to be executed, and operation returns to fetching (122) the next fetch packet. Otherwise, operation ends (136).

FIG. 5 illustrates a conventional non-VLIW processor. The processor may be a Reduced Instruction Set Computing (RISC) processor such as those of the ARM, PowerPC, or MIPS architectures, or a Complex Instruction Set Computing (CISC) processor such as those of the X86 architecture, and will be generically referred to as a RISC/CISC processor (to distinguish it from a VLIW processor, and not to imply either a RISC or a CISC machine).

A RISC/CISC compiler generates RISC/CISC executable code according to the source code. The compiler knows about the processor's instruction set architecture (ISA), which includes e.g. the number and identities of registers and the available instructions. The compiler generates sequential instructions, rather than multi-instruction words (like a VLIW compiler would).

The processor may include a prefetcher which is used to bring instructions and/or data into an instruction cache and a data cache, respectively. The processor typically utilizes a microarchitecture which is somewhat different than the ISA. The processor includes execution units which executes microinstructions or “μops” which are typically of a very different format than the ISA instructions, especially in a CISC architecture. It also includes a register file for holding data.

An instruction fetcher sequentially retrieves instructions from the executable code, usually via the instruction cache, which are then decoded by an instruction decoder. Some instructions, typically the more “RISCy” ones, are directly decoded into “μops”. Other instructions, typically the more “CISCy” ones, are not directly decoded into μops, but trigger the processor to retrieve a sequence of μops from a microcode read-only memory (ROM). Regardless of whether the μops come from the instruction decoder, from the microcode ROM, or from elsewhere, a micro-instruction scheduler controls their issuance to the appropriate execution units.

If the processor is an “in-order” machine, it executes the ISA executable code instructions' corresponding μops strictly in the order specified by the compiler. For example, the “ADD” instruction shown in the first (bottommost) position in the executable code (of FIG. 5) is programmatically before the subsequent “SUB” and “BEQ” instructions in the second and third positions. Therefore, the processor will execute the “ADD” instruction's μop(s) before it executes the “SUB” instruction's μop(s), and it will then execute the “SUB” instruction's μop(s) before it executes the “BEQ” instruction's μop(s).

However, if the processor is an “out-of-order” machine, it will further include a reordering mechanism enabling the processor to, under certain conditions, execute the μops in a somewhat different order than that specified by the ISA code. The compiler may have applied some level of intelligence to the source code already, for example moving long-latency instructions (e.g. memory reads) to positions earlier in the code stream than the source code would indicate; it can do this as long as it does not e.g. cause a data dependency error by moving a consumer instruction ahead of a producer instruction, where the consumer instruction uses the producer instruction's result as an input operand. The compiler may also apply other types of optimizations, such as loop unrolling.

The processor's reordering mechanism adds some additional intelligence to the processor, enabling it to reorder instructions (still without violating data dependencies and the like) under certain other conditions. For example, the compiler might not be able to know, for certain, whether the processor will hit or miss the cache when executing a particular instruction. By executing out of programmatic order, the processor can get work done during such instances which would otherwise stall the execution pipeline.

Some out-of-order processors also perform “speculative execution”, in which they execute down both the “taken” and “not taken” targets of a conditional branch instruction, without retiring those instructions' results to “machine state”. Then, when it becomes known whether the branch is or is not taken, the instructions that were down the wrong branch target can simply be discarded, and those that were down the correct branch target can be committed to machine state and retired.

The hardware necessary for maintaining correct program functionality in such machines is generally quite significant, both in die area and design complexity.

FIG. 6 illustrates a method of operation of the microprocessor of FIG. 5. The microprocessor can be described as having a “front end” and a “back end” which operate somewhat independently. Operation of the front end begins (140) and the microprocessor fetches (142) the next instruction from memory or the cache. The fetched instruction is decoded (144) and any data dependencies are resolved (146). Then, when (148) the scheduler is able to receive the instruction, the instruction is sent (150) to the scheduler. If (152) the end of the code has not yet been reached, the front end returns to fetching (142) the next instruction.

Operation of the back end begins (160) with the scheduler waiting (162) until it receives an instruction from the decoder. Then, the scheduler waits (164) until that instruction's input operand data are all available, and (166) an appropriate execution unit is available. Then, the scheduler issues (168) the instruction to that execution unit, which executes (170) the instruction. The scheduler then returns to waiting (162) for an instruction, which may have already been received.

Eventually, the front end reaches (152) the end of the executable code, and its operation ends (154), at which point the back end will be left waiting (162) for another instruction to execute.

In order to increase performance by exploiting instruction level parallelism (ILP), conventional RISC/CISC processors are made “wider” with multiple execution pipelines, multiple instruction decoders, and so forth. But at some relatively small width number—typically in the range of 2 to 4, depending upon the architecture and the implementation—the performance increase from going wider quickly approaches zero in an in-order machine. An out-of-order execution machine is better able to keep a wider set of execution units busy. Unfortunately, out-of-order implementations are much more complicated, take more die area, consume more power, and are harder to scale in frequency than in-order machines. Many manufacturers are now going to dual-core and multi-core devices, in essence pushing ILP exploitation back to the software writers and the compiler.

What is desirable is a hybrid machine which offers the simple, efficient, fast, and scalable advantages of a VLIW execution engine, without suffering from VLIW NOP code bloat, and which can execute conventional RISC/CISC code and thereby decouple the VLIW-like aspects of the implementation from the compiler's view, such that the code does not need to be recompiled for each implementation of the architecture. In other words, what is desirable is a machine whose software and front end offer the advantages of a RISC/CISC machine, and whose back end offers the advantages of a VLIW machine.

### BRIEF DESCRIPTION OF THE DRAWINGS

FIG. 1 shows a conventional VLIW processor according to the prior art.

FIG. 2 shows a method of operation of the VLIW processor of FIG. 1.

FIG. 3 shows one possible implementation of a VLIW processor according to the prior art.

FIG. 4 shows a method of operation of the VLIW processor of FIG. 3.

FIG. 5 shows an exemplary RISC or CISC microprocessor according to the prior art.

FIG. 6 shows a method of operation of the microprocessor of FIG. 5.

FIG. 7 shows a digital signal processor (DSP) according to one embodiment of this invention.

FIG. 8 shows further detail of the DSP of FIG. 7.

FIG. 9 shows one entry in the UCPacket.

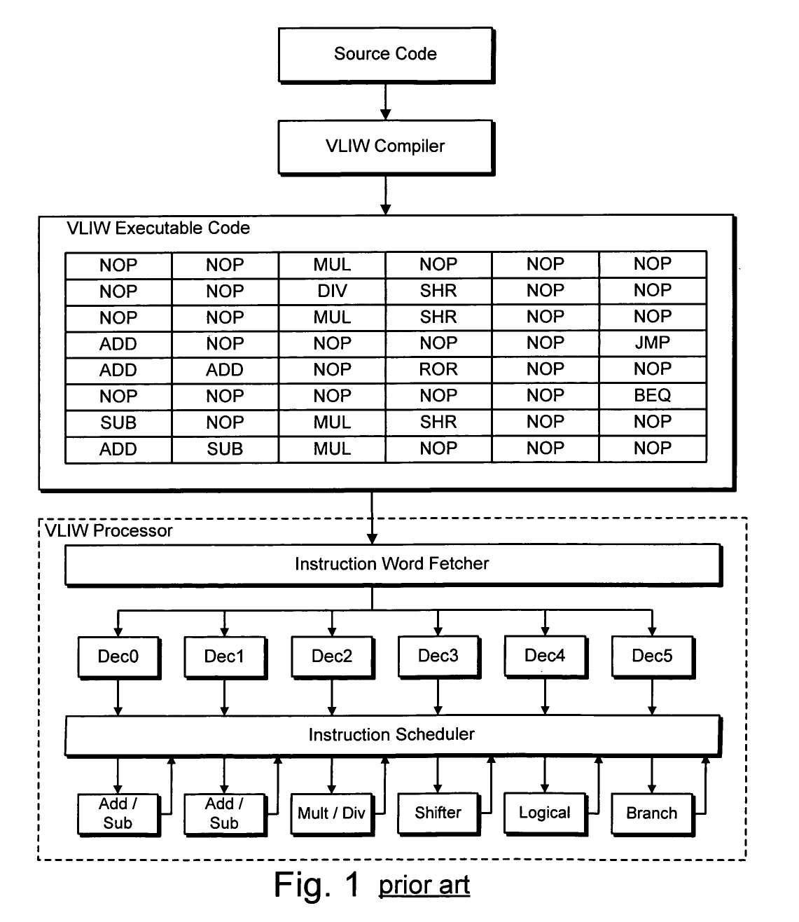

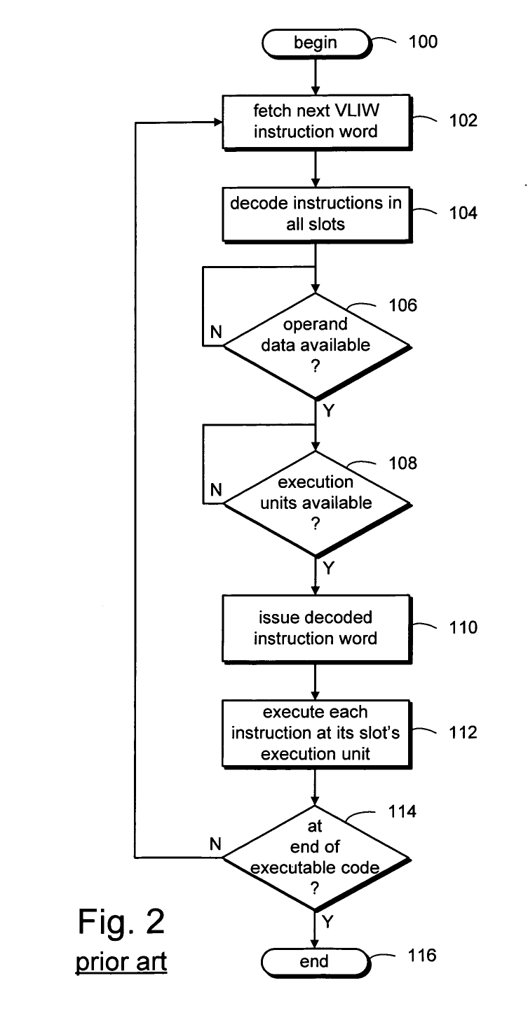

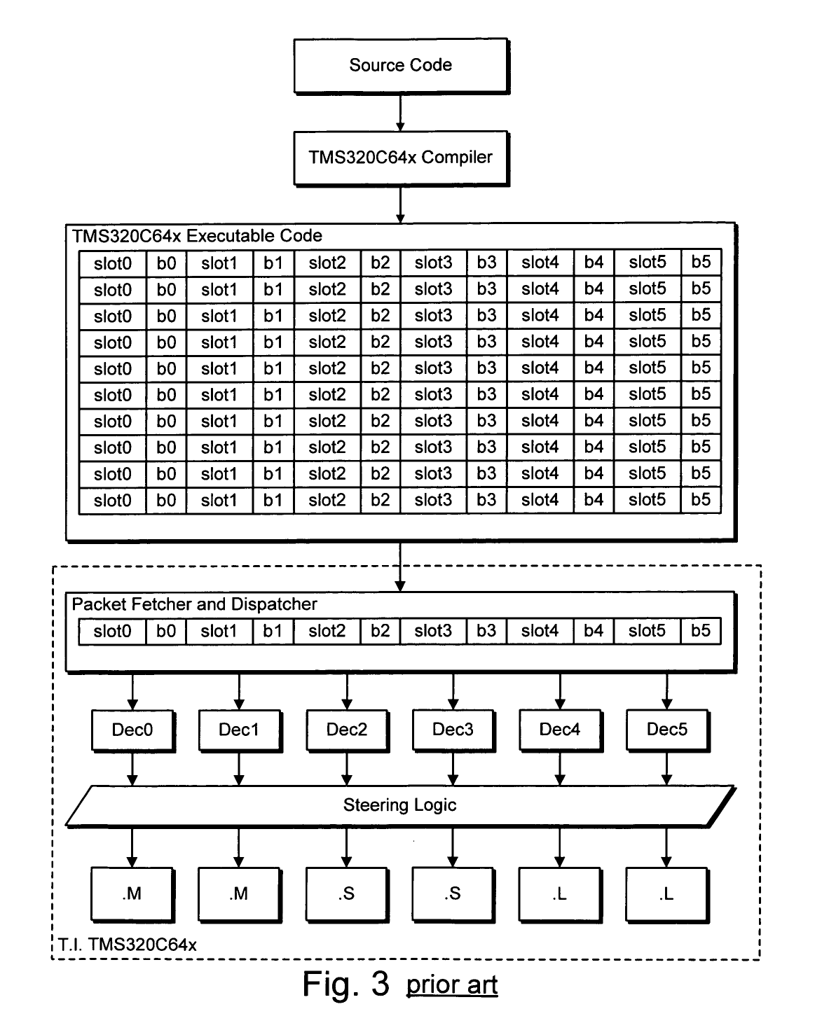

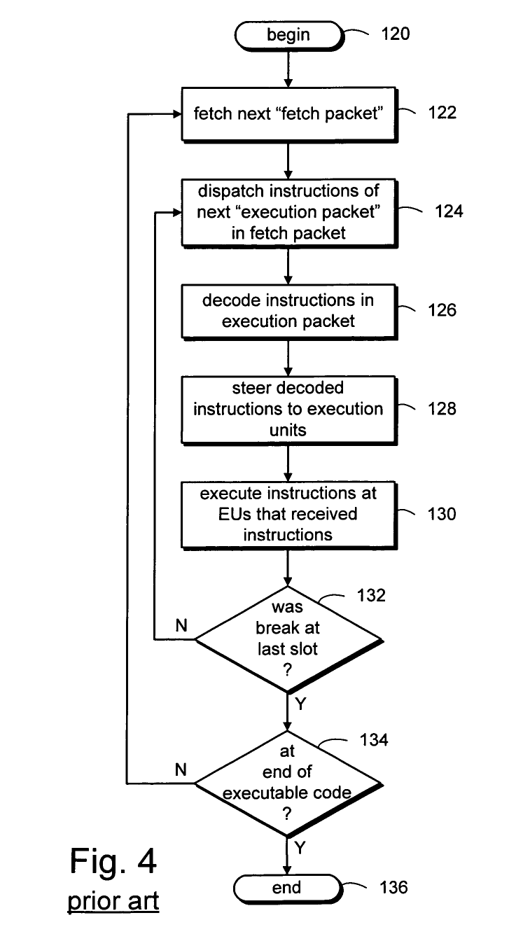

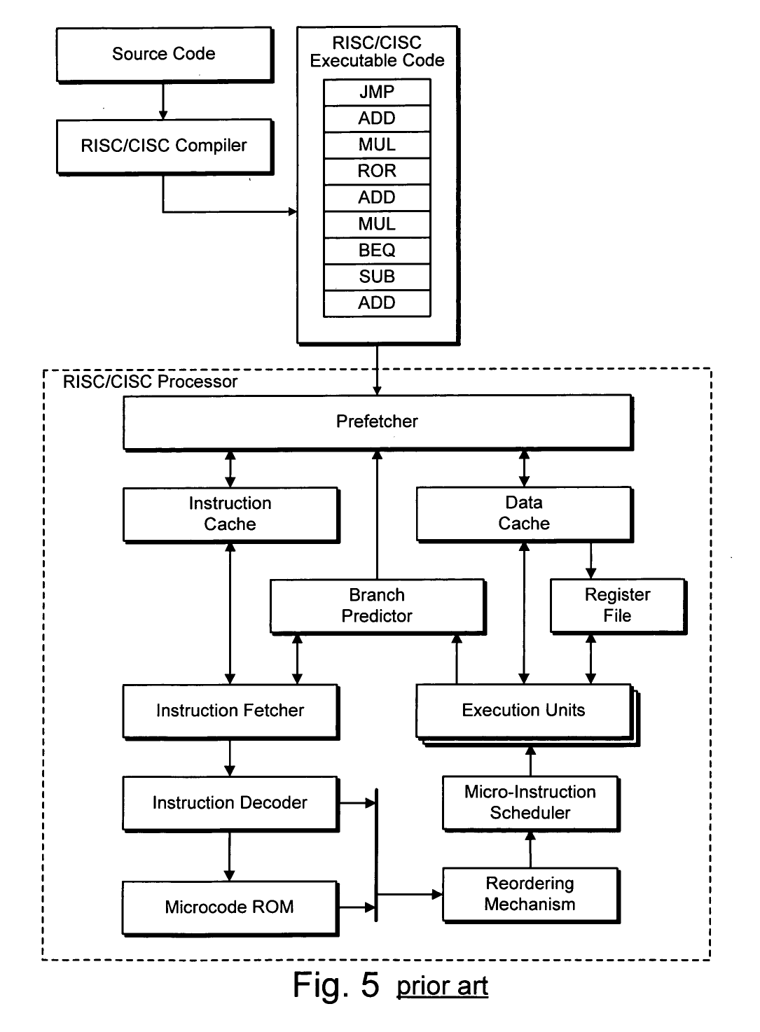

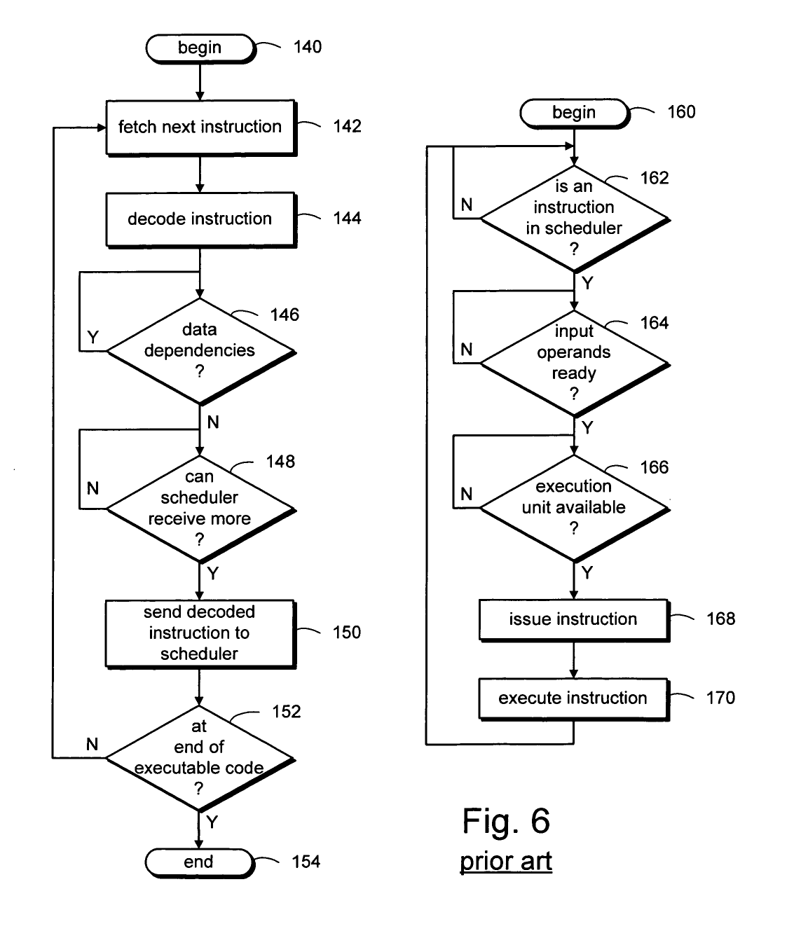

### DETAILED DESCRIPTION

The invention will be understood more fully from the detailed description given below and from the accompanying drawings of embodiments of the invention which, however, should not be taken to limit the invention to the specific embodiments described, but are for explanation and understanding only.

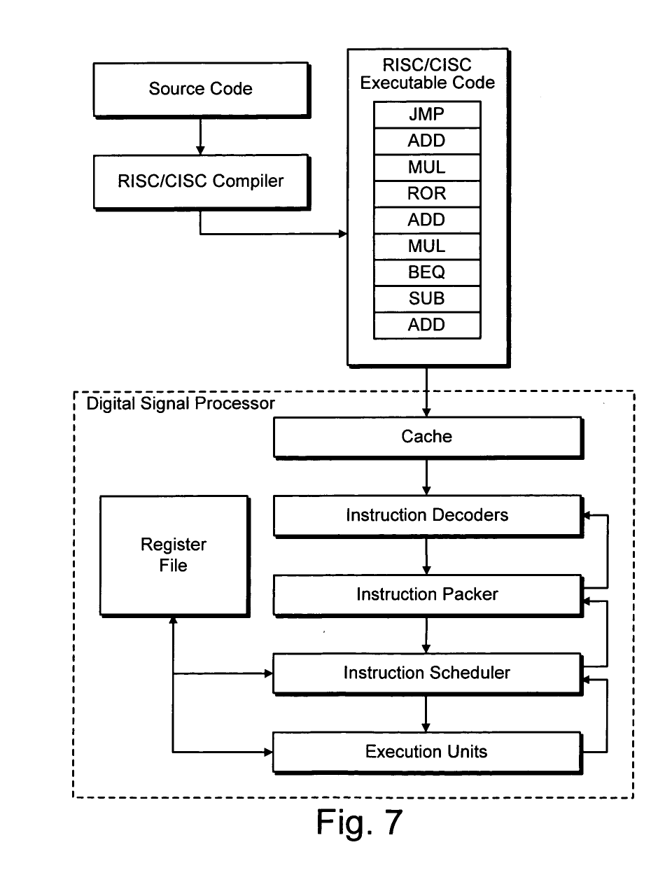

FIG. 7 illustrates a digital signal processor (DSP) according to one embodiment of this invention. The DSP executes RISC/CISC instructions which are compiled from source code by a RISC/CISC compiler into an executable program.

The DSP includes a cache which interfaces to the external memory/storage system (not shown), and one or more instruction decoders which decode incoming ISA instructions into their respective corresponding μop(s). An instruction packer receives the μops from the instruction decoders, packs them into an instruction packet (described below) which an instruction scheduler receives and schedules for execution by a plurality of execution units. A register file provides data storage for instruction results.

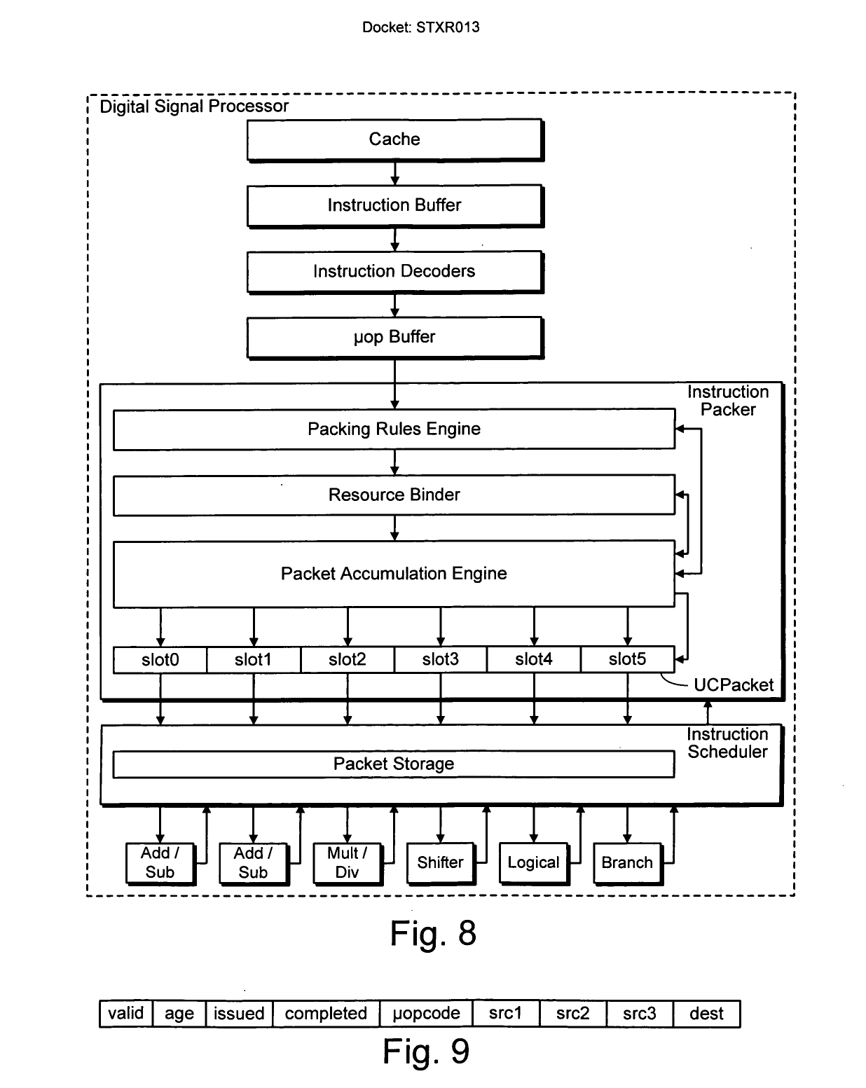

FIG. 8 illustrates the DSP of FIG. 7 in greater detail. The DSP includes a cache, an instruction decoder(s), and an instruction buffer which decouples the cache from the instruction decoder. The instruction buffer operates in FIFO fashion, but can be constructed using any suitable mechanism, such as a ring buffer, a flow-through buffer, or what have you.

The DSP includes a μop buffer which is receives the μops from the decoder and provides them to the instruction packer. The μop buffer decouples the instruction packer from the instruction decoder, and can be constructed as a FIFO, ring buffer, etc.

The instruction packer includes a packing rules engine which determines whether each new μop can be packed into the same instruction packet as previously packed μops, or whether there is a packet breaking condition which prevents it from being packed with them.

An instruction packet is, in essence, a VLIW instruction word, for execution by the DSP's execution units in VLIW fashion, meaning that each “slot” or μop in the instruction packet is aligned with and uniquely bound to a particular, corresponding execution unit. The instruction packer constructs an instruction packet referred to as the UCPacket (for “Under Construction Packet”), which it eventually passes on to the instruction scheduler.

The packing rules determine which of the μops can be packed into the UCPacket. The packing rules can be any constraints whatsoever, depending upon the architecture, microarchitecture, and design implementation of the particular DSP. Exemplary rules for an in-order implementation may include such constraints as:
a μop having a data dependency on another μop cannot share the packet with the other μop
conditional branch μops cannot share the packet with μops from any other instruction
no more than two ADD/SUB μops per packet
no more than one MULT/DIV μop per packet
an unconditional branch μop cannot share the packet with any Logical μop
no more than one branch per packet
no more than eight μops per packet
for some ISA instructions which decode into multiple μops, some of these μops must be in the same packet (must break before the first if the last doesn't fit)
   or any other suitable constraints. These are only given by way of example; an actual machine will have its own set of constraints.

The impending breakage of any packing rule is a “packet breaking condition”. The packer stops packing the UCPacket when any rule would otherwise be broken. Any unfilled slots in the UCPacket are then filled with “NOP” instructions, either literally by being filled with the NOP opcode bit pattern, or effectively by having a flag bit or valid bit cleared or the like.

The instruction packer also includes a resource binder which controls the slot positioning of the μops as they pass through the packing rules engine. The resource binder determines which type of execution unit the particular μop calls for, and also determines whether there is one of those slots still available in the UCPacket. The absence of a suitable slot is a packet breaking condition, which the resource binder signals to a packet accumulation engine and the packing rules engine.

The instruction packer includes a packet accumulation engine which determines whether the instruction packer should continue trying to pack more μops into the UCPacket, or whether the UCPacket should be shipped off to the packet storage of the instruction scheduler “as is”. If the packing rules engine or the resource binder indicates a packet breaking condition, the packet accumulator attempts to ship the UCPacket to the instruction scheduler. Even if there is no packet breaking condition, the packet accumulation engine may decide to end packing of the current UCPacket, for example if the instruction scheduler is about to run out of previous instruction packets. (It may typically prove more beneficial to keep the scheduler fed with even sub-optimally-packed packets, than to let it starve.) The packet storage of the instruction scheduler decouples the instruction packer from the execution units.

The DSP includes a plurality of execution units, each in a predetermined “slot”. For example, the DSP may include two Add/Sub (addition and subtraction) units, a Mult/Div (multiplication and division) unit, a shifter, a logical unit for performing AND, OR, etc. instructions, and a branch unit for performing branch instructions. The DSP may include any number of execution units. For ease of illustration, it is shown with six, but in other embodiments there may be e.g. eight execution units or sixteen execution units, or any suitable number. The UCPacket includes corresponding instruction slots—corresponding in number, location, and functionality type.

In one embodiment, as long as there is at least one packet waiting in the scheduler, the packer is allowed to continue packing the currently under-construction packet. This will, in many instances, enable overall performance to be increased by reducing the number of “NOP” instructions in the packets when they arrive at the execution units.

However, when the packer encounters a “packet-breaking” condition, it cannot perform any further packing, and, as long as there is at least one empty entry in the ring buffer, the packet accumulation engine sends the UCPacket to the scheduler. For example, if all packet slots have been filled with non-NOP instructions, no further packing is possible. Or, if the programmatically-next instruction is e.g. a conditional branch which cannot share a packet with other instructions, no further packing is possible. Or, if all of the Add/Sub slots have been filled and the next instruction is another ADD instruction, no further packing is possible.

The DSP issues and executes instructions in VLIW fashion. The DSP is an in-order machine. One reason that this is significant is that, because the executable code is constructed as in-order code and not VLIW instruction words, the DSP must be able to correctly handle precise exceptions.

For example, in the code example given, if the MUL, ADD, and ROR instruction sequence (shown in FIG. 7 in the 4^{th} through 6^{th} positions in the executable code) is packed into a single UCPacket, and the MUL causes a data size overflow exception, the processor must be able to handle the ADD and ROR instructions in exactly the same manner as if it had executed the instructions strictly in order, notwithstanding the fact that the ADD and ROR were packed into the same packet as the MUL. Typically, what would happen in that case, is that execution would transfer to an exception handler in the operating system, which may e.g. saturate the MUL result at the maximum possible value, then execution would return to the ADD and then the ROR. In the case in which the MUL, ADD, and ROR have all been sent for simultaneous execution in VLIW fashion, the DSP must be able to prevent the ADD and ROR instructions from committing state when the MUL exception is detected.

The UCPacket includes six instructions in slot0 through slot5. These slots correspond to the physical positioning of the various execution units, and do not necessarily correspond to the order of the instructions in the program. In the example given above, the MUL would be in slot2, the ADD in slot0, and the ROR in slot3; the ADD comes before the MUL in the UCPacket in slot order, even though the MUL comes before the ADD in the program order.

FIG. 9 illustrates one embodiment of data structures which facilitate this recovery, within a single slot of the UCPacket. The slot includes a “valid” field which indicates whether the other fields contain meaningful values. In one embodiment, the valid field may be cleared to create a virtual NOP.

The slot further includes an “age” field which indicates the relative age of that instruction within the UCPacket. For example, the MUL may be assigned an age value of 0, the ADD an age value of 1, and the ROR an age value of 2. Thus, the age field simply indicates the programmatic order of the instructions in the UCPacket. In one embodiment, age fields of slots holding packer-generated NOP instructions may be assigned sequential values greater than the largest age value assigned to an actual instruction.

The slot further includes an issued flag bit which indicates whether the instruction has been issued for execution. The slot further includes a complete flag bit which indicates that the instruction has been completely executed, including the handling of any events.

The slot includes a μopcode field which indicates the opcode of the μop. The slot further includes one or more source identifier fields (e.g. src1, src2, src3), each of which identifies a source from which operand data will be taken in executing the instruction, and a destination identifier field (dest) which identifies a destination to which result data will be written. The sources may include immediate data.

When an instruction causes an event, each instruction whose age field has a value larger (indicating that it is programmatically younger) than that of the instruction which caused the event, will need to be prevented from committing state and from setting the complete flag. After the event condition is resolved, the valid and/or issued and/or completed bits of all older instructions in the same packet, including the one that caused the exception, can be cleared, to prevent those from being re-executed—thus they will be treated as though they were NOPs, by their execution units. Valid, non-complete μops can then be re-executed to finish execution of the packet.

The following segments of pseudo-code illustrate two different methods of operation of the packer. The primary difference between the two is this. If the first method reaches the end of the group of μops received by the packer without shipping the UCPacket to the scheduler, it starts over, attempting to do better packing, with a newly received group of instructions which may be larger. Any μops that were packed the first time will simply be re-packed the second time. If the second method reaches the end of the group of μops received by the packer without shipping the UCPacket to the scheduler, it continues by sliding to a new group of μops retrieved from the μop buffer, leaving the previously-packed μops in their slots in the UCPacket.

These and a variety of other algorithms may be used in implementing the instruction packer's method of operation.

# RE-PACKING METHOD
UopBufferPointer = &UopBuffer; # begin at start of buffer
repeat

| { NumOps = GetUopsFromBuffer ( ); | # get μops that have not been |
|---|---|
| | # written to the scheduler |
| | # even if previously packed |

NumPacked = 0;
PacketBreakingCondition = false;
for i = 1 to NumOps do # actually done in parallel in hardware
{ if ((DataDependency ( ) == false) AND

(SlotAvailable ( ) == true) AND
(OtherPacketBreakingConditions ( ) == false))

{ Pack ( );

NumPacked++;

}
else
{ PacketBreakingCondition = true;

break; # exit for loop

}

} # for
if ((PacketBreakingCondition == true) OR

(SchedulerStarved ( ) == true) OR
(NumPacked == NumSlots) )

{ WritePacketToScheduler ( );

UopBufferPointer += NumPacked;

}

} # repeat

# SLIDING PACKING METHOD
PacketBreakingCondition = false;
NumPacked = 0;
repeat
{ NumOps = GetUopsFromBuffer ( );

for i = 1 to NumOps do # actually done in parallel in hardware
{ if ((DataDependency ( ) == true) OR

(SlotAvailable ( ) == false) OR
(RuleBreak ( ) == true) )

{ PacketBreakingCondition = true;

break; # leave the for loop early

}
if (PacketBreakingCondition == false)
{ Pack ( );

NumPacked++;

}

} # for
if ((PacketBreakingCondition == true) OR

(SchedulerStarved ( ) == true) OR
(NumPacked == NumSlots) )

{ WritePacketToScheduler ( );

PacketBreakingCondition = false;
NumPacked = 0;

}

} # repeat

### CONCLUSION

When one component is said to be “adjacent” to another component, it should not be interpreted to mean that there is absolutely nothing between the two components, only that they are in the order indicated.

The various features illustrated in the figures may be combined in many ways, and should not be interpreted as though limited to the specific embodiments in which they were explained and shown.

Those skilled in the art having the benefit of this disclosure will appreciate that many other variations from the foregoing description and drawings may be made within the scope of the present invention. Indeed, the invention is not limited to the details described above. Rather, it is the following claims including any amendments thereto that define the scope of the invention.

What is claimed is:

1. A processor comprising:
a plurality of execution units each adapted for executing a respective set of instructions;
means for providing a plurality of sequential instructions;
an instruction packer coupled to receive sequential instructions from the means for providing instructions and adapted to pack a plurality of the received sequential instructions into respective slots of an instruction packet which includes a plurality of slots each associated with a respective one of the execution units; and
an instruction scheduler coupled to receive the instruction packet from the instruction packer and to dispatch the instruction packet to the execution units for execution.

2. The processor of claim 1 wherein the means for providing comprises:
an instruction decoder for decoding ISA instructions into μops; wherein the μops comprise the sequential instructions.

3. The processor of claim 2 wherein the means for providing further comprises:
a μop buffer coupled to receive the μops from the instruction decoder, and coupled to provide the μops to the instruction packer.

4. The processor of claim 1 wherein the instruction packer comprises:
a packing rules engine adapted to enforce a predetermined set of rules which identify when packing of the instruction packet cannot continue.

5. The processor of claim 4 wherein the predetermined set of rules includes rules mandating that:
if a second instruction has a data dependency upon a first instruction, the second instruction cannot be in the same packet as the first instruction.

6. The processor of claim 4 wherein the predetermined set of rules includes rules mandating that:
if a first μop and a second μop need to be atomically executed together, the first and second μops must be packed into the same packet.

7. The processor of claim 1 wherein:
the instruction packet further includes a plurality of age indicators each associated with a corresponding one of the slots; and
the instruction packer is further adapted to place a value in the age indicator of the slot into which it packs a given instruction, thereby indicating a sequential program order of the plurality of instructions packed into the instruction packet.

8. The processor of claim 7 further comprising:
means for performing precise exception handling during execution of the packed instructions of the packet.

9. The processor of claim 1 wherein:
the instruction packer is adapted to attempt to pack more instructions into the instruction packet in a next packing cycle if the current packing cycle ends without the instruction packet being dispatched from the instruction packer to the instruction scheduler.

10. A method whereby a processor executes sequential instructions, the method comprising:
receiving the sequential instructions;
packing a plurality N of the sequential instructions into an instruction packet having a plurality M of slots, wherein N<=M;
issuing the instruction packet to a plurality M of execution units; and
each of the plurality of execution units executing a respective corresponding slot's packed instruction;
wherein the instruction packet is executed in VLIW fashion.

11. The method of claim 10 wherein:
N<M, such that the instruction packet includes at least one empty slot; and
execution of the at least one empty slot comprises treating the slot as containing a NOP instruction which was not present in the sequential instructions.

12. The method of claim 10 further comprising:
applying a plurality of packing rules each capable of indicating a packet breaking condition; and
upon detecting a packet breaking condition, sending the instruction packet to be issued.

13. The method of claim 12 wherein the packing rules comprise:
if a second instruction has a data dependency upon a first instruction, the second instruction cannot be in the same packet as the first instruction.

14. The method of claim 12 wherein the packing rules comprise:
if a given instruction is of a type to be executed by an execution unit type for which all corresponding instruction packet slots are already occupied by packed instructions, the given instruction cannot be in the same packet.

15. The method of claim 12 wherein the packing rules further comprise:
if a first μop and a second μop need to be atomically executed together, the first and second μops must be packed into the same packet.

16. The method of claim 10 further comprising:
decoding a plurality of ISA instructions into a plurality of μops, wherein the sequential instructions comprise the μops.

17. The method of claim 16 further comprising:
buffering the μops between the decoding and the packing.

18. The method of claim 16 further comprising:
if after all μops from a current decode cycle have been packed without encountering a packet-breaking condition, continuing to pack μops from a next decode cycle into the instruction packet.

19. The method of claim 18 wherein:
the plurality of ISA instructions from the current decode cycle are re-decoded in the next decode cycle along with zero or more additional ISA instructions.

20. The method of claim 18 wherein:
ISA instructions from the current decode cycle whose μops are packed in the current packing cycle are not re-decoded in the next decode cycle, such that the next decode cycle begins with decoding of an oldest ISA instruction yielding at least one μop which was not packed in the current decode cycle.

21. A method of executing RISC/CISC instructions by a processor, the method comprising:
in a first decode cycle, decoding a first plurality of the RISC/CISC instructions into a first plurality of μops;
packing a plurality N of the sequential instructions into an instruction packet having a plurality M of slots, wherein N<=M;
issuing the instruction packet to a plurality M of execution units; and
each of the plurality of execution units executing a respective corresponding slot's packed instruction;
wherein the instruction packet is executed in VLIW fashion.

22. The method of claim 21 wherein:
N<M, such that the instruction packet includes at least one empty slot; and
execution of the at least one empty slot comprises treating the slot as containing a NOP instruction which was not present in the sequential instructions.
